(19) United States
(12) Patent Application Publication
(10) Pub. No.: US 2024/0023749 A1
(43) Pub. Date: Jan. 25, 2024

(54) COOKING UTENSIL FOR PREVENTING BURNS

(71) Applicant: Jung Hyun You, Cincinnati, OH (US)

(72) Inventor: Jung Hyun You, Cincinnati, OH (US)

(21) Appl. No.: 18/374,741

(22) Filed: Sep. 29, 2023

Related U.S. Application Data
(63) Continuation of application No. PCT/KR2022/004353, filed on Mar. 28, 2022.

(30) Foreign Application Priority Data
Mar. 31, 2021 (KR) 10-2021-0042114

(51) Int. Cl. A47J 36/02; A47J 37/10; A47J 45/06; F16B 1/00

(52) U.S. Cl. CPC A47J 36/02; A47J 37/10; A47J 45/061; F16B 1/00; F16B 2200/83

(57) ABSTRACT

A cooking utensil for preventing burns is provided. The cooking utensil comprises a container part and a burn prevention part. The container part includes a bottom portion, a perimeter portion, and an insertion groove. The burn prevention part includes a support portion, a cap portion, a flange portion, and at least one elastic member. The flange portion and the support portion may be made of magnetic materials that attract each other. Accordingly, when the container part is heated, the support portion and the flange portion made of the magnetic materials lose the magnetic properties thereof and move upward by means of the upper side of the elastic member, thus minimizing the effect of the heating of the container part and preventing the person cooking from being burned by the upper portion of the container part.

### CROSS-REFERENCE TO RELATED APPLICATIONS

This application is a continuation of International Application No. PCT/KR2022/004353 filed on Mar. 28, 2022, which claims priority to Korean Patent Application No. 10-2021-0042114 filed on Mar. 31, 2021, the entire contents of which are herein incorporated by reference.

### TECHNICAL FIELD

The disclosure relates to a cooking utensil for preventing burns, and more particularly, to a cooking utensil for preventing burns which prevents a cook from burning his/her hand by a cooking utensil while cooking.

### BACKGROUND ART

In general, when a high-temperature flame and heat are directly applied to a cooking utensil, the cooking utensil is heated by the flame and heat to cook the food in a container of the cooking utensil, and a handle protrudes outward from the container of the cooking utensil so as to prevent the flame from reaching the handle and is usually made of wood or heat-resistant synthetic resin with low thermal conductivity so that the handle may be held by hand.

However, there is a risk that a cook's arm touches the top of the container of the cooking utensil while the cook cooks cooking ingredients in the container of the cooking utensil with tools such as a spatula or chopsticks, and in particular, when the cook's arm touches the top of the hot container of the cooking utensil, he or she may immediately get burned.

### SUMMARY

### Technical Problem

An objective of the disclosure is to provide a cooking utensil for preventing burns which prevents a cook from being burned by a container of the cooking utensil while cooking food.

Another objective of the disclosure is to provide a cooking utensil for preventing burns in which a burn prevention unit located at an upper end of a container of the cooking utensil automatically moves up and down according to a temperature, thereby improving the convenience of a cook.

However, the objectives of the disclosure are not limited thereto, and other unmentioned objectives will be apparent to one of ordinary skill in the art from the following description.

### Technical Solution

A cooking utensil for preventing burns according to the disclosure includes a container unit that is open at top and contains ingredients therein, and a burn prevention unit provided on an upper side of the container unit, wherein the container unit includes a bottom portion, a peripheral portion extending upward from a boundary of the bottom portion, and an insertion groove recessed from an upper end of the peripheral portion toward the bottom portion, wherein the burn prevention unit includes a support portion located in the insertion groove, a cap portion located on the support portion and formed of a material having a lower thermal conductivity than the container unit, a flange portion located in the insertion groove and spaced apart from a lower side of the support portion, and at least one elastic member located between the flange portion and the support portion and configured to provide an elastic force to the support portion in an upward direction, and wherein the flange portion and the support portion are formed of magnetic materials exerting attractive forces on each other.

Details of other embodiments are included in the detailed description and the accompanying drawings.

### Advantageous Effects

According to embodiments of the disclosure, a cook may be prevented from being burned by a container of a cooking utensil while cooking food. Also, because a burn prevention unit located at an upper end of the cooking utensil automatically moves up and down according to a temperature, the cook does not need to separately operate the burn prevention unit, thereby improving the convenience of the cook.

Effects of the disclosure are not limited thereto, and other unmentioned effects will be clearly understood by one of ordinary skill in the art from the appended claims.

### DESCRIPTION OF DRAWINGS

FIG. 1 is a plan view illustrating a cooking utensil for preventing burns, according to an embodiment of the disclosure.

FIG. 2 is a rear view for describing a burn prevention unit of FIG. 1.

FIG. 3 is a schematic view for describing the cooking utensil for preventing burns of FIG. 1.

FIG. 4 is a schematic view for describing an operation process of the cooking utensil for preventing burns of FIG. 1.

FIG. 5 is a perspective view illustrating a cooking utensil for preventing burns, according to another embodiment of the disclosure.

FIG. 6 is a rear view for describing a burn prevention unit of FIG. 5.

FIG. 7 is a schematic view for describing the cooking utensil for preventing burns of FIG. 5.

FIG. 8 is a schematic view for describing an operation process of the cooking utensil for preventing burns of FIG. 5.

FIG. 9 is a schematic view illustrating a cooking utensil for preventing burns, according to another embodiment of the disclosure.

FIG. 10 is an enlarged view illustrating a portion A of FIG. 9.

FIG. 11 is a schematic view for describing an operation process of the cooking utensil for preventing burns of FIG. 9.

FIG. 12 is an enlarged view illustrating a portion B of FIG. 11.

### DETAILED DESCRIPTION

The advantages and features of the disclosure and methods of achieving them will become apparent with reference to embodiments of the disclosure described in detail below with reference to the accompanying drawings. The disclosure may, however, be embodied in many different forms and should not be construed as limited to embodiments set forth herein; rather these embodiments are provided so that this disclosure will be thorough and complete, and will fully convey the scope of the disclosure only defined by the claims to one of ordinary skill in the art. In the specification, the same reference numerals denote the same elements.

The embodiments of the disclosure will be described with reference to cross-sectional views and/or plan views which are ideal exemplary views of the disclosure. In the drawings, thicknesses of elements are exaggerated for effective explanation of technical content. Therefore, regions illustrated in the drawings have schematic properties, and shapes of the regions illustrated in the drawings are illustrative of specific shapes of the regions and are not intended to limit the scope of the disclosure. It will be understood that, although the terms first, second, etc. may be used in various embodiments of the disclosure to describe various elements, these elements should not be limited by these terms. These terms are used only for the purpose of distinguishing a certain element from the others. The exemplary embodiments described herein include exemplary embodiments complementary thereto.

The terms used herein are for the purpose of describing embodiments only and are not intended to limit the disclosure. As used herein, the singular forms “a,” “an,” and “the” are intended to include the plural forms as well, unless the context clearly indicates otherwise. It will be further understood that the terms “comprises” and/or “comprising” used herein specify the presence of stated elements, steps, operations, and/or devices, but do not preclude the presence or addition of one or more other elements, steps, operations, and/or devices.

Unless otherwise defined, all terms herein (including technical and scientific terms) have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the concept of the disclosure and embodiments of the disclosure will be described in detail with reference to the drawings.

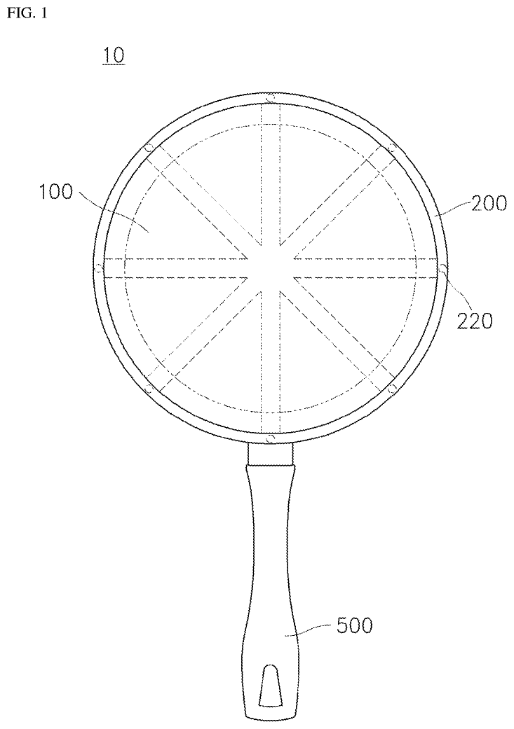

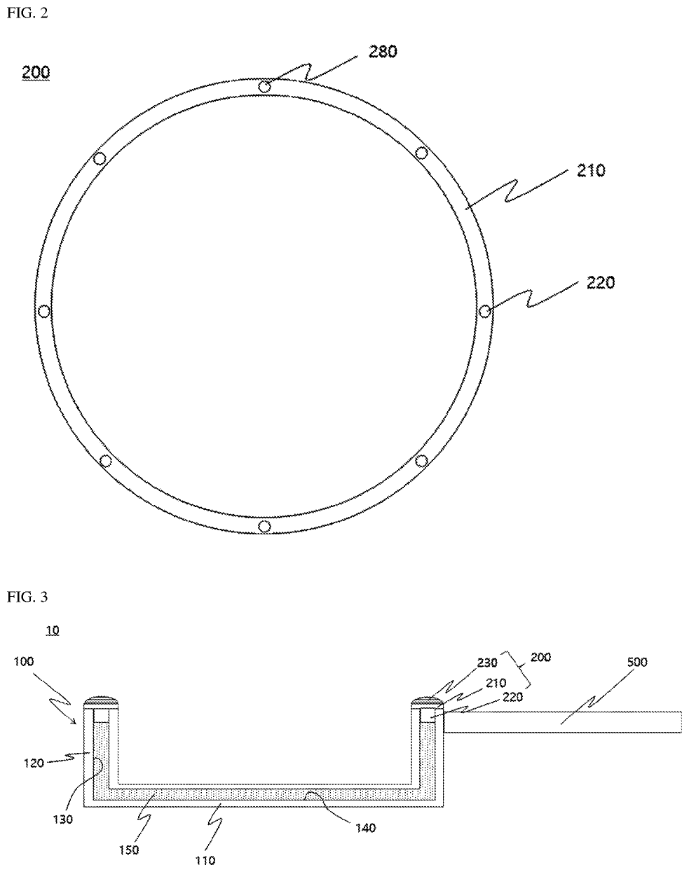

FIG. 1 is a plan view illustrating a cooking utensil for preventing burns, according to an embodiment of the disclosure. FIG. 2 is a rear view for describing a burn prevention unit of FIG. 1. FIG. 3 is a schematic view for describing the cooking utensil for preventing burns of FIG. 1.

Referring to FIGS. 1 to 3, a cooking utensil for preventing burns 10 according to an embodiment of the disclosure may prevent a cook from being burned while cooking. In an embodiment, the cooking utensil for preventing burns 10 may be, but is not limited to, a frying pan. The cooking utensil for preventing burns 10 may include a container unit 100, a burn prevention unit 200, and a handle unit 500.

The container unit 100 may be open at the top and may have a cooking space in which ingredients are contained. The container unit 100 may include a bottom portion 110, a peripheral portion 120, at least one first flow path 130, and a thermal expansion member 150. Also, the container unit 100 may further include at least one second flow path 140.

The bottom portion 110 may form a bottom surface of the container unit 100. In an embodiment, the bottom portion 110 may be a flat plate. Alternatively, in another embodiment, the bottom portion 110 may be a curved plate that is slightly convex downward. The bottom portion 110 may have a circular shape in a plan view, but the disclosure is not limited thereto. The bottom portion 110 may be spaced apart downward from the opening.

The peripheral portion 120 may extend upward from a boundary of the bottom portion 110. The peripheral portion 120 may surround the cooking space of the container unit 100. In an embodiment, the peripheral portion 120 may have, but is not limited to, a cylindrical shape.

Each of the bottom portion 110 and the peripheral portion 120 may be formed of a metal material or a ceramic material having excellent thermal conductivity. In an embodiment, each of the bottom portion 110 and the peripheral portion 120 may be formed of, but not limited to, a steel material such as stainless steel.

The first flow path 130 may be located in the peripheral portion 120. The first flow path 130 may be a hole or a groove extending from an upper end of the peripheral portion 120 toward the bottom portion 110. In an embodiment, the first flow path 130 may be formed long in a vertical direction of the peripheral portion 120.

One or more first flow paths 130 may be formed. In an embodiment, a plurality of first paths flow 130 may be provided. The plurality of first flow paths 130 may be arranged along a circumference of the container unit 100 and/or the peripheral portion 120. In an embodiment, four first flow paths 130 may be arranged at regular intervals along the circumference of the container unit 100 and/or the peripheral portion 120.

The second flow path 140 may be located in the bottom portion 110. The second flow path 140 may be connected to the first flow path 130. In an embodiment, one end of the second flow path 140 may be connected to any one of the four first flow paths 130. The other end of the second flow path 140 may be connected to another one of the four first flow paths 130. Accordingly, the second flow path 140 may cross the bottom portion 110 while passing through the center of the bottom portion 110. The first flow path 130 connected to the other end of the second flow path 140 may face the first flow path 130 connected to one end of the first flow path 130.

A plurality of second flow paths 140 may be provided. The plurality of second flow paths 140 may intersect each other. In an embodiment, two second flow paths 140 may intersect each other into a cross shape in a plan view, but the disclosure is not limited thereto.

The thermal expansion member 150 may be expanded or contracted by heat. In an embodiment, when heat is applied to the thermal expansion member 150, the volume of the thermal expansion member 150 may be increased. Also, when heat of the thermal expansion member 150 is absorbed, the volume of the thermal expansion member 150 may be reduced.

The thermal expansion member 150 may be located in the first flow path 130. Also, the thermal expansion member 150 may be located in the second flow path 140 connected to the first flow path 130. A thermal expansion coefficient of the thermal expansion member 150 may be greater than a thermal expansion coefficient of the container unit 100. In an embodiment, the container unit 100 may be formed of a ferrous metal material, and the thermal expansion member 150 may be formed of zinc, aluminum, manganese, or copper. However, the disclosure is not limited thereto.

The burn prevention unit 200 may be provided on an upper side of the container unit 100. The burn prevention unit 200 may be located at the upper end of the peripheral portion 120 of the container unit 100. The burn prevention unit 200 may move in the vertical direction according to expansion and contraction of the thermal expansion member 150. The burn prevention unit 200 may include a support portion 210, at least one inserted protrusion 220, and a cap portion 230. The burn prevention unit 200 may further include a rotation fixing portion 280.

The support portion 210 may be located on the peripheral portion 120. The support portion 210 may cover the upper end of the peripheral portion 120. In an embodiment, the support portion 210 may be formed in a ring shape. Alternatively, in another embodiment, the support portion 210 may have a structure in which a plurality of arc shapes are arranged along the upper end of the peripheral portion 120.

The support portion 210 may be formed of a material having a lower thermal conductivity than the container unit 100. In an embodiment, when the container unit 100 is formed of a steel material such as stainless steel, the support portion 210 may be formed of a ceramic material. Alternatively, in another embodiment, the support portion 210 may be formed of another material.

The inserted protrusion 220 may protrude from a lower side of the support portion 210 downward and/or toward the bottom portion 110. The inserted protrusion 220 may be inserted into the first flow path 130. The inserted protrusion 220 may be inserted into the first flow path 130 while being in close contact with an inner wall of the first flow path 130. Accordingly, the burn prevention unit 200 may be coupled to the container unit 100.

A plurality of inserted protrusions 220 may be provided. The plurality of inserted protrusions 220 may be arranged along a circumference of the support portion 210 having a ring shape. The inserted protrusion 220 may be formed of the same material as the support portion 210.

The cap portion 230 may be located on the support portion 210. For example, the cap portion 230 may be located on an upper side of the support portion 210. The cap portion 230 may be formed of a material having a lower thermal conductivity than the container unit 100. Also, the cap portion 230 may be formed of a material having a lower thermal conductivity than the support portion 210 and/or the inserted protrusion 220. For example, the cap portion 230 may be formed of, but not limited to, silicone.

The rotation fixing portion 280 may be located on the support portion 210. The rotation fixing portion 280 may protrude downward from a lower side of the support portion 210. The rotation fixing portion 280 may be inserted into a fixing groove (not shown). The rotation fixing portion 280 may protrude further downward than the inserted protrusion 220. Accordingly, even when the burn prevention unit 200 moves upward and the inserted protrusion 220 is separated from the first flow path 130, the rotation fixing portion 280 may be inserted into the fixing groove. Accordingly, the burn prevention unit 200 may be prevented from being separated from the container unit 100 or rotating on the container unit 100.

The handle unit 500 may be an element that allows a cook to lift or move the container unit 100. The handle unit 500 may be provided on the container unit 100. The handle unit may be a portion held by the cook with his/her hand. The handle unit 500 may be provided on the peripheral portion 120 of the container unit 100. In an embodiment, the handle unit 500 may be formed of, but not limited to, plastic or wood. In an embodiment, there may be one handle unit 500. One handle unit 500 may be formed long in one direction.

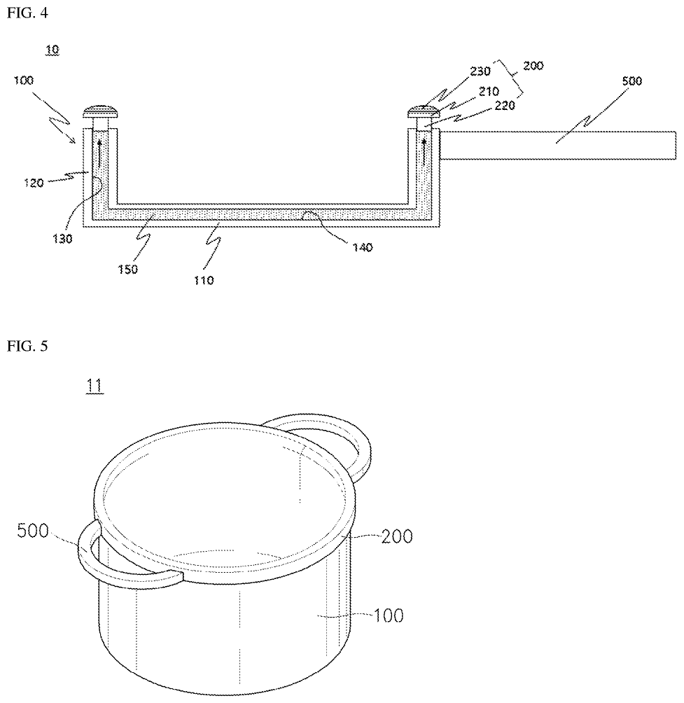

FIG. 4 is a schematic view for describing an operation process of the cooking utensil for preventing burns of FIG. 1.

Referring to FIGS. 1 to 4, a user may heat the cooking utensil for preventing burns 10 to cook food. Accordingly, the container unit 100 of the cooking utensil for preventing burns 10 may be heated. Accordingly, heat may be transferred to the thermal expansion member 150 located in the first flow path 130 and the second flow path 140.

When heat is applied to the thermal expansion member 150, the volume of the thermal expansion member 150 may be increased. When the thermal expansion member 150 is expanded, the thermal expansion member 150 may press the burn prevention unit 200 upward. Accordingly, the support portion 210 of the burn prevention unit 200 may be separated from the upper end of the peripheral portion 120 and may move upward.

As the burn prevention unit 200 moves upward, the burn prevention unit 200 may minimize absorption of heat transferred from the container unit 100. Accordingly, heat transferred to the cap portion 230 may be minimized, thereby preventing a temperature of the cap portion 230 from rising to a certain temperature or more. Because the temperature rise of the cap portion 230 is limited, the cook may be prevented from being burned while cooking.

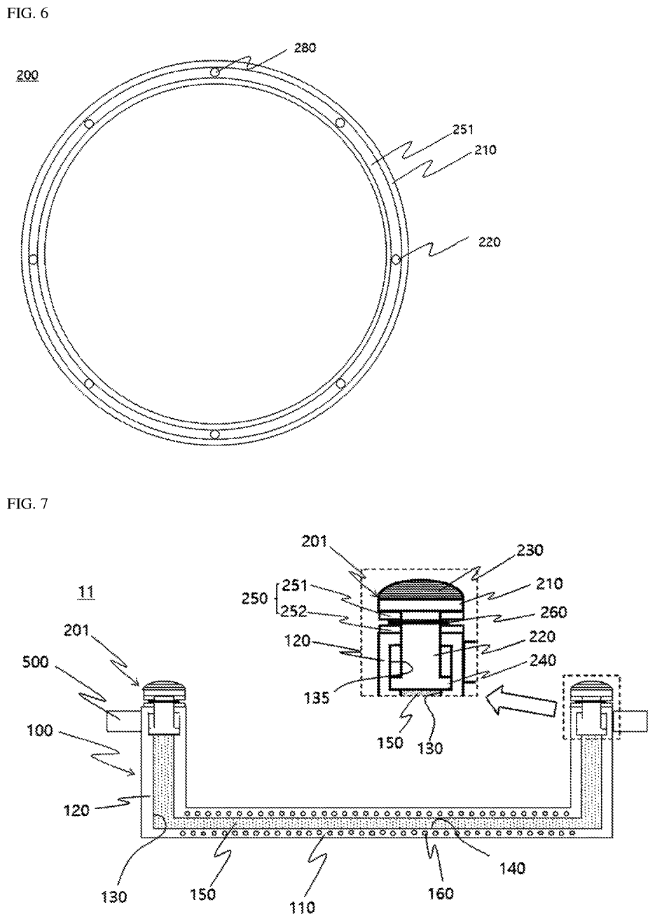

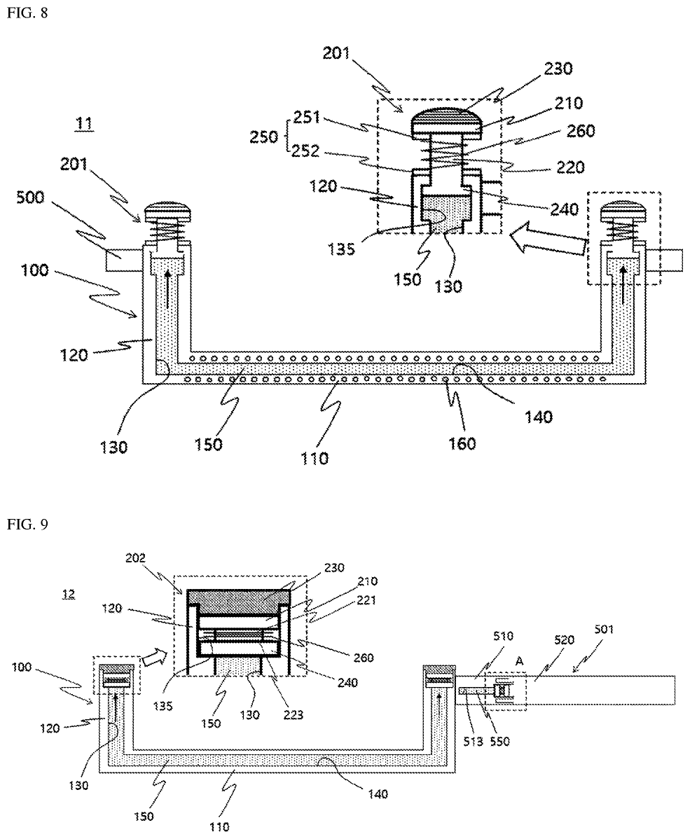

FIG. 5 is a perspective view illustrating a cooking utensil for preventing burns, according to another embodiment of the disclosure. FIG. 6 is a rear view for describing a burn prevention unit of FIG. 5. FIG. 7 is a schematic view for describing the cooking utensil for preventing burns of FIG. 5. The same elements as those described with reference to FIGS. 1 to 3 will not be described or will be briefly described.

Referring to FIGS. 5 to 7, a cooking utensil for preventing burns 11 according to another embodiment of the disclosure may be a cooking pot. The cooking utensil for preventing burns 11 may include the container unit 100, a burn prevention unit 201, and the handle unit 500.

The container unit 100 may include the bottom portion 110, the peripheral portion 120, at least one first flow path 130, at least one second flow path 140, the thermal expansion member 150, and a coil portion 160. The container unit 100 may further include a stopper groove 135.

The bottom portion 110 may form a bottom surface of the container unit 100. The peripheral portion 120 may extend upward from a boundary of the container unit 100. The first flow path 130 may be located in the peripheral portion 120. The second flow path 140 may be located in the bottom portion 110. In an embodiment, the first flow path 130 may be provided in a ring shape in a plan view. In other words, the first flow path 130 may be formed in a circular shape along an upper end of the peripheral portion 120.

The stopper groove 135 may be recessed from an inner wall of the peripheral portion 120 in a direction away from the first flow path 130. Accordingly, a width of the stopper groove 135 may be greater than a width of the first flow path 130. The stopper groove 135 may be connected to the first flow path 130. The stopper groove 135 may be located adjacent to the upper end of the peripheral portion 120. In the specification, the inner wall of the peripheral portion 120 may be a surface contacting the first flow path 130. The stopper groove 135 may be spaced apart downward from the upper end of the peripheral portion 120.

The coil portion 160 may be located in the bottom portion 110. The coil portion 160 may spirally surround the second flow path 140. The coil portion 160 may be formed of a material having a higher thermal conductivity than the container unit 100. In an embodiment, the coil portion 160 may be formed of a material such as, but not limited to, copper, aluminum, gold, or silver. Accordingly, the heat conduction efficiency of the cooking utensil for preventing burns 11 to the thermal expansion member 150 in the second flow path 140 may be improved by the coil portion 160.

The burn prevention unit 201 may be located on an upper side of the container unit 100. The burn prevention unit 201 may include the support portion 210, at least one inserted protrusion 220, the cap portion 230, a flange portion 240, a magnet unit 250, and an elastic member 260.

The flange portion 240 may protrude in a direction away from the inserted protrusion 220. The flange portion 240 may be located adjacent to a lower end of the inserted protrusion 220. The flange portion 240 may be inserted into the stopper groove 135 described above. The flange portion 240 may slide in a vertical direction in the stopper groove 135. As the flange portion 240 moves in the stopper groove 135, the burn prevention unit 201 may be prevented from being separated from the container unit 100 due to an expansive force of the thermal expansion member 150.

The magnet unit 250 may function to attach the burn prevention unit 201 to the container unit 100. The magnet unit 250 may include a first magnet member 251 and a second magnet member 252. The first magnet member 251 may be located on the support portion 210. The second magnet member 252 may be located on the upper end of the peripheral portion 120. In an embodiment, each of the first magnet member 251 and the second magnet member 252 may be provided in a ring shape corresponding to the support portion 210. Also, each of the first magnet member 251 and the second magnet member 252 may include at least one through-hole (not shown) through which the inserted protrusion 220 passes. In an embodiment, the first magnet member 251 and the second magnet member 252 may be spaced apart from each other by the elastic member 260.

An attractive force may act between the first magnet member 251 and the second magnet member 252. For example, the first magnet member 251 may be an N-pole and the second magnet member may be an S-pole. Accordingly, when an expansive force of the thermal expansion member 150 is not applied, a state where the burn prevention unit 201 is attached to the container unit 100 may be maintained.

The elastic member 260 may be located between the first magnet member 251 and the second magnet member 252. The elastic member 260 may provide an elastic force to the first magnet member 251 and the second magnet member 252 in a direction opposite to the attractive force acting between the first magnet member 251 and the second magnet member 252. Accordingly, the elastic member 260 may provide an elastic force to the support portion 210 in an upward direction.

In an embodiment, the elastic member 260 may surround a part of the inserted protrusion 220. Alternatively, in another embodiment, a plurality of elastic members 260 may be provided. The plurality of elastic members 260 may be spaced apart from each other with the inserted protrusion 220 therebetween. In an embodiment, the elastic member 260 may be formed of, but not limited to, a non-magnetic material.

When heat is applied to the first magnet member 251 and the second magnet member 252 to increase a temperature, magnetism may be lost due to magnetic phase transition. As such, when there is no attractive force between the first magnet member 251 and the second magnet member 252, the elastic member 260 may move the burn prevention unit 201 upward. A plurality of elastic members 260 may be provided. The plurality of elastic members 260 may be arranged along a circumference of the inserted protrusion 220.

Alternatively, in another embodiment, when the container unit 100 is formed of a ferrous metal material, the magnet unit 250 may not include the second magnet member 252. There may be an attractive force between the first magnet member 251 located on the support portion 210 and the peripheral portion 120. However, when a temperature of the first magnet member 251 rises, the attractive force with the peripheral portion 120 may be lost or weakened. Also, the elastic member 260 may be located between the first magnet member 251 and the upper end of the peripheral portion 120. The elastic member 260 may provide an elastic force to the support portion 210 in an upward direction.

The handle unit 500 may be provided on the container unit 100. In an embodiment, a plurality of handle units 500 may be provided.

FIG. 7 is a schematic view for describing an operation process of the cooking utensil for preventing burns of FIG. 5.

Referring to FIGS. 5 to 7, the cook may heat the cooking utensil for preventing burns 11 to cook food. Accordingly, the container unit 100 of the cooking utensil for preventing burns 11 may be heated. In other words, heat may be transferred to the thermal expansion member 150 located in the first flow path 130 and the second flow path 140. Also, the heat of the container unit 100 may heat the coil portion 160. Because the coil portion 160 has a higher thermal conductivity than the container unit 100, heat may be efficiently provided to the thermal expansion member 150 in the second flow path 140.

When heat is applied to the thermal expansion member 150, the volume of the thermal expansion member 150 may be increased. As the thermal expansion member 150 is expanded, the thermal expansion member 150 may press the burn prevention unit 201 upward.

The heated container unit 100 may transfer heat to the magnet unit 250. A temperature of the magnet unit 250 receiving heat from the container unit 100 may rise. As the temperature of the magnet unit 250 rises, the magnet unit 250 may lose its magnetism due to magnetic phase transition. Accordingly, an attractive force acting between the first magnet member 251 and the second magnet member 252 may be lost or weakened.

When the attractive force acting between the first magnet member 251 and the second magnet member 252 is lost or weakened, an elastic force of the elastic member 260 located between the first magnet member 251 and the second magnet member 252 may be provided to the burn prevention unit 201 in an upward direction.

In an embodiment, because the attractive force between the first magnet member 251 and the second magnet member 252 is lost or weakened and an expansive force of the thermal expansion member 150 and the elastic force of the elastic member 260 is provided to the burn prevention unit, the burn prevention unit 201 may move upward. In other words, a separation distance between the support portion 210 and the upper end of the peripheral portion 120 may increase.

As the burn prevention unit 201 moves upward, the burn prevention unit 201 may minimize absorption of heat transferred from the container unit 100. Accordingly, heat transferred to the cap portion 230 may be minimized and a temperature of the cap portion 230 may be prevented from rising to a certain temperature or more. As the temperature rise of the cap portion 230 is limited, the cook may be prevented from being burned while cooking.

Even when the burn prevention unit 201 moves upward, because the flange portion 240 is inserted into the stopper groove 135, the burn prevention unit 201 may not move upward by a certain distance or more.

When the user completes cooking, heat supply to the container unit 100 may be stopped. Accordingly, temperatures of the container unit 100, the thermal expansion member 150, and the magnet unit 250 may decrease.

As the temperature of the thermal expansion member 150 decreases, the thermal expansion member 150 may be contracted. Also, when the temperature of the magnet unit 250 decreases, the magnet unit 250 may restore its magnetism. That is, an attractive force may act again between the first magnet member 251 and the second magnet member 252.

As an attractive force acts between the first magnet member 251 and the second magnet member 252 and an expansive force of the thermal expansion member 150 is lost or weakened, the burn prevention unit 201 may move downward. That is, the burn prevention unit 201 may return to a state before the user cooks.

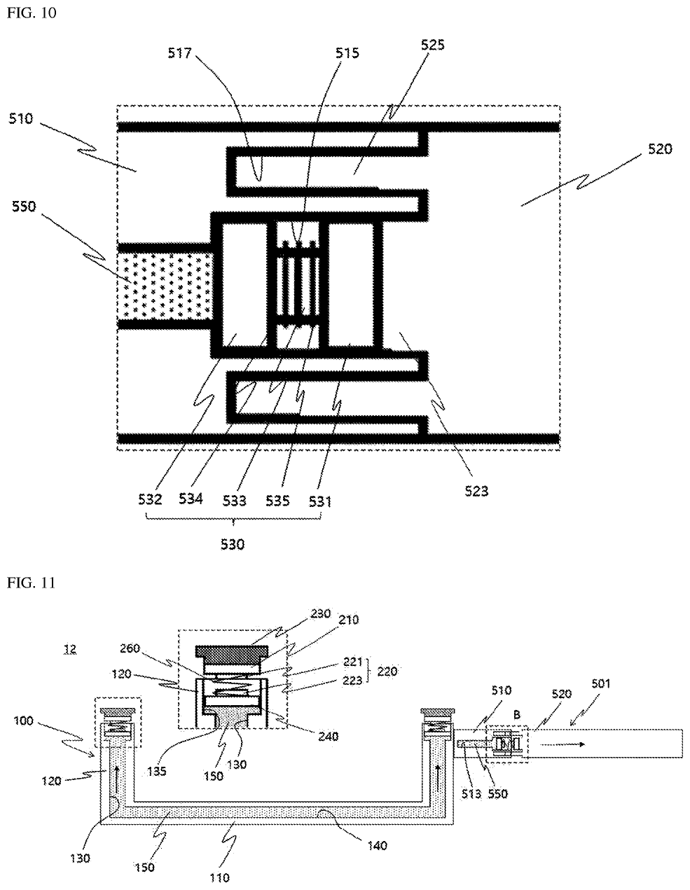

FIG. 9 is a schematic view illustrating a cooking utensil for preventing burns, according to another embodiment of the disclosure. FIG. 10 is an enlarged view illustrating a portion A of FIG. 9. The same elements as those described with reference to FIGS. 1 to 3 will not be described or will be briefly described.

Referring to FIGS. 9 and 10, a cooking utensil for preventing burns 12 according to another embodiment of the disclosure may include the container unit 100, a burn prevention unit 202, and a handle unit 501.

The container unit 100 may include the bottom portion 110, the peripheral portion 120, at least one first flow path 130, at least one second flow path 140, and the thermal expansion member 150. The container unit 100 may further include an insertion groove 135. The container unit 100 may include the coil portion 160 (see FIG. 7), but in the present embodiment, the coil portion 160 is omitted.

The bottom portion 110 may form a bottom surface of the container unit 100. The peripheral portion 120 may extend upward from a boundary of the container unit 100. The first flow path 130 may be located in the peripheral portion 120. The second flow path 140 may be located in the bottom portion 110.

The insertion groove 135 may be recessed from an upper end of the peripheral portion 120 toward the bottom portion 110. In an embodiment, the insertion groove 135 may be formed in a ring shape in a plan view.

The first flow path 130 may extend from the insertion groove 135 toward the bottom portion 110. The first flow path 130 may be located in the peripheral portion 120. A width of the insertion groove 135 may be greater than a width of the first flow path 130. The insertion groove 135 may be connected to the first flow path 130. A length of the insertion groove 135 may be less than a length of the first flow path 130. In the specification, an inner wall of the peripheral portion 120 may be a surface contacting the first flow path 130.

The burn prevention unit 201 may be located on an upper side of the container unit 100. The burn prevention unit 201 may include the support portion 210, at least one inserted protrusion 220, the cap portion 230, the flange portion 240, and the elastic member 260.

The support portion 210 may be located in the insertion groove 135. The flange portion 240 may be located in the insertion groove 135, and may be located below the support portion 210. The support portion 210 and the flange portion 240 may be spaced apart from each other. In an embodiment, each of the support portion 210 and the flange portion 240 may be provided in a ring shape in a plan view.

The inserted protrusion 220 may connect the flange portion 240 to the support portion 210. In an embodiment, a width of the support portion 210 and a width of the flange portion 240 may be greater than a width of the inserted protrusion 220. The flange portion 240 may be inserted into the insertion groove 135 described above. The flange portion 240 may slide in the insertion groove 135 in the vertical direction.

Each of the support portion 210 and the flange portion 240 may be formed of a magnetic material. In an embodiment, a surface of the flange portion 240 facing the support portion 210 may be an N-pole, and a surface of the support portion 210 facing the flange portion 240 may be an S-pole. Accordingly, an attractive force may act between the support portion 210 and the flange portion 240. Accordingly, the elastic member 260 between the support portion 210 and the flange portion 240 may be compressed.

The inserted protrusion 220 may be located between the support portion 210 and the flange portion 240. In an embodiment, a plurality of inserted protrusions 220 may be provided. The plurality of inserted protrusions 220 may be arranged at regular intervals along a circumference of the support portion 210 and the flange portion 240 having a ring shape. Alternatively, in another embodiment, the inserted protrusion 220 may be provided in a ring shape in a plan view, like the support portion 210 and the flange portion 240.

The inserted protrusion 220 may include a first protrusion 221 and a second protrusion 223. The first protrusion 221 and the second protrusion 223 may be separated. The first protrusion 221 may protrude from the support portion 210 toward the flange portion 240. The second protrusion 223 may protrude from the flange portion 240 toward the support portion 210.

The first protrusion 221 includes a plurality of first protrusions 221 and the second protrusion 223 includes a plurality of second protrusions 223. The plurality of first protrusions 221 may be arranged along the circumference of the support portion 210. The second protrusions 223 may be arranged along a circumference of the flange portion 240.

The first protrusion 221 may be inserted into the elastic member 260. In an embodiment, the first protrusion 221 may be inserted into an upper portion of the elastic member 260 that is a spring. The second protrusion 223 may be inserted into the elastic member 260. In an embodiment, the second protrusion 223 may be inserted into a lower portion of the elastic member 260 that is a spring.

The first protrusion 221 and the second protrusion 223 may be attached to and detached from each other due to a magnetic force between the support portion 210 and the flange portion 240 or an elastic force of the elastic member 260. Accordingly, when the first protrusion 221 and the second protrusion 223 are attached to each other due to a magnetic force between the support portion 210 and the flange portion 240, the inserted protrusion 220 may connect the support portion 210 to the flange portion 240.

The elastic member 260 may be located between the support portion 210 and the flange portion 240. One or more elastic members 260 may be provided. The elastic member 260 may provide an elastic force to the support portion 210 and the flange portion 240 in a direction opposite to an attractive force acting between the support portion 210 and the flange portion 240. Accordingly, the elastic member 260 may provide an elastic force to the support portion 210 in an upward direction.

In an embodiment, the elastic member 260 may surround the inserted protrusion 220. In other words, the first protrusion 221 and the second protrusion 223 may be inserted into the elastic member 260. Accordingly, the elastic member 260 may be prevented from being separated from a space between the support portion 210 and the flange portion 240.

The handle unit 501 may be formed on the container unit 100. The handle unit 501 may include a first bar portion 510, a second bar portion 520, and a sub-burn prevention unit 530.

One end of the first bar portion 510 may be connected to the container unit 100. The first bar portion 510 may be formed long in one direction from the container unit 100. The first bar portion 510 may include a third flow path 513, a sub-groove 515, a sub-thermal expansion member 550, and a guide groove 517.

The third flow path 513 may be recessed from the other end of the first bar portion 510 toward the container unit 100. In an embodiment, the third flow path 513 may be formed long along a longitudinal direction of the first bar portion 510.

The sub-thermal expansion member 550 may be located in the third flow path 513. The sub-thermal expansion member 550 may be expanded or contracted by heat. In an embodiment, when heat is applied to the sub-thermal expansion member 550, the volume of the sub-thermal expansion member 550 may be increased. Also, when heat of the sub-thermal expansion member 550 is absorbed, the volume of the sub-thermal expansion member 550 may be reduced. A thermal expansion coefficient of the sub-thermal expansion member 550 may be greater than a thermal expansion coefficient of the first bar portion 510 and the second bar portion 520. In an embodiment, each of the first bar portion 510 and the second bar portion 520 of the handle unit 501 may be formed of a PEN material, and the sub-thermal expansion member 550 may be formed of a PET material.

The sub-groove 515 may be recessed from an inner wall of the first bar portion 510 in a direction away from the third flow path 513. Accordingly, the sub-groove 515 may be connected to the third flow path 513, and a width of the sub-groove 515 may be greater than a width of the third flow path 513. The sub-groove 515 may be recessed from the other end of the first bar portion 510 toward the container unit. However, a length of the third flow path 513 may be greater than a length of the sub-groove 515. In the specification, the inner wall of the first bar portion 510 may be a surface contacting the third flow path 513.

The guide groove 517 may be recessed from the other end of the first bar portion 510 toward the container unit 100. The guide groove 517 may be spaced apart from the third flow path 513 and the sub-groove 515. In an embodiment, a pair of guide grooves 517 may be formed. The pair of guide grooves 517 may be spaced apart from each other with the third flow path 513 and the sub-groove 515 therebetween. The guide groove 517 may be formed long along the longitudinal direction of the first bar portion 510.

The second bar portion 520 may be connected to the other end of the first bar portion 510. The second bar portion 520 may be formed long along the longitudinal direction of the first bar portion 510. The second bar portion 520 may be connected to the container unit 100 through the first bar portion 510. The second bar portion 520 may include a first guide insertion portion 523 and at least one second guide insertion portion 525. The second bar portion 520 may be a portion held by the cook with his/her hand.

The first guide insertion portion 523 may be inserted into the third flow path 513 and the sub-groove 515. The second guide insertion portion 525 may be spaced apart from the first guide insertion portion 523. In an embodiment, a pair of second guide insertion portions 525 may be provided. The pair of second guide insertion portions 525 may be spaced apart from each other with the first guide insertion portion 523 therebetween. The second guide insertion portion 525 may be inserted into the guide groove 517.

The first guide insertion portion 523 and the second guide insertion portion 525 may function to connect the first bar portion 510 to the second bar portion 520. Also, the second guide insertion portion 525 may function to prevent the second bar portion 520 from being separated from the first bar portion 510 when the second bar portion 520 moves away from the first bar portion 510.

The sub-burn prevention unit 530 may allow the second bar portion 520 to move along the longitudinal direction of the first bar portion 510 according to expansion of the sub-thermal expansion member 550. Accordingly, when the handle unit 501 is heated, the sub-burn prevention unit 530 may move the second bar portion 520 in a direction away from the first bar portion 510 to minimize heating of the second bar portion 520. Because the heating of the second bar portion 520 is minimized, the cook may be prevented from being burned through the handle unit 501. The sub-burn prevention unit 530 may be provided between the first bar portion 510 and the second bar portion 520.

The sub-burn prevention unit 530 may include a sub-flange portion 532, a sub-support portion 531, a first sub-protrusion 533, a second sub-protrusion 534, and a sub-elastic member 535.

The sub-support portion 531 may be provided in the second bar portion 520. In an embodiment, the sub-support portion 531 may be provided in the first guide insertion portion 523.

The sub-flange portion 532 and the sub-support portion 531 may be spaced apart from each other. The sub-flange portion 532 and the sub-support portion 531 may be located in the sub-groove 515. The sub-flange portion 532 and the sub-support portion 531 may be formed of magnetic materials exerting attractive forces on each other. In an embodiment, a surface of the sub-flange portion 532 facing the sub-support portion 531 may be an S-pole, and a surface of the sub-support portion 531 facing the sub-flange portion 532 may be an N-pole. Accordingly, an attractive force may act between the sub-support portion 531 and the sub-flange portion 532.

The first sub-protrusion 533 may protrude from the sub-support portion 531 toward the sub-flange portion 532. The second sub-protrusion 534 may protrude from the sub-flange portion 532 toward the sub-support portion 531. The first sub-protrusion 533 and the second sub-protrusion 534 may be attached to and detached from each other due to an attractive force between the sub-flange portion 532 and the sub-support portion 531 or an elastic force of the elastic member.

A width of the first sub-protrusion 533 may be less than a width of the sub-support portion 531. A width of the second sub-protrusion 534 may be less than a width of the sub-flange portion 532.

The sub-elastic member 535 may be located between the sub-support portion 531 and the sub-flange portion 532. The sub-elastic member 535 may be located in the sub-groove 515 and the third flow path 513. The sub-elastic member 535 may provide an elastic force in a direction opposite to an attractive force acting between the sub-support portion 531 and the sub-flange portion 532. Accordingly, the sub-elastic member 535 may provide an elastic force to the sub-support portion 531 in a direction away from the container unit 100. The sub-elastic member 535 may be formed of, but not limited to, a non-magnetic material.

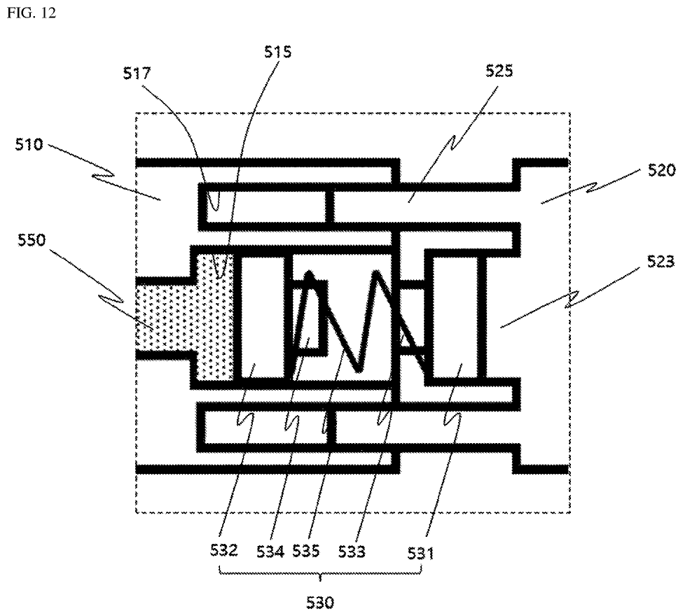

FIG. 11 is a schematic view for describing an operation process of the cooking utensil for preventing burns of FIG. 9. FIG. 12 is an enlarged view illustrating a portion B of FIG. 11.

Referring to FIGS. 9 to 12, the cook may heat the cooking utensil for preventing burns 12 to cook food. Accordingly, the container unit 100 may be heated. Accordingly, heat may be transferred to the thermal expansion member 150 located in the first flow path 130 and the second flow path 140.

When heat is applied to the thermal expansion member 150, the volume of the thermal expansion member 150 may be increased. As the thermal expansion member 150 is expanded, the thermal expansion member 150 may press the burn prevention unit 202 upward.

The heated container unit 100 may transfer heat to the support portion 210 and the flange portion 240 of the burn prevention unit 202. Temperatures of the support portion 210 and the flange portion 240 receiving heat may rise. As the temperatures of the support portion 210 and the flange portion 240 rise, the support portion 210 and the flange portion 240 may lose their magnetism due to magnetic phase transition. Accordingly, an attractive force acting between the support portion 210 and the flange portion 240 may be lost or weakened.

When the attractive force applied between the support portion 210 and the flange portion 240 is lost or weakened, an elastic force of the elastic member 260 located between the support portion 210 and the flange portion 240 may be provided to the burn prevention unit 202 or the support portion 210 in an upward direction. Accordingly, the burn prevention unit 202 may move upward. In other words, a separation distance between the support portion 210 and the upper end of the peripheral portion 120 may increase.

As the burn prevention unit 202 moves upward, the burn prevention unit 202 may minimize absorption of heat transferred from the container unit 100. Accordingly, heat transferred to the cap portion 230 may be minimized and a temperature of the cap portion 230 may be prevented from rising to a certain temperature or more. As the temperature rise of the cap portion 230 is limited, the cook may be prevented from being burned while cooking.

The heated container unit 100 may transfer heat to the handle unit 501. Accordingly, the handle unit 501 of the cooking utensil for preventing burns 12 may be heated. In other words, heat may be transferred to the sub-thermal expansion member 550 located in the third flow path 513.

When the heat is applied to the sub-thermal expansion member 550, the volume of the sub-thermal expansion member 550 may be increased. As the sub-thermal expansion member 550 is expanded, the sub-thermal expansion member 550 may press the sub-burn prevention unit 530 in a direction away from the container unit.

The heated unit 501 may transfer heat to the sub-flange portion 532 and the sub-support portion 531 of the sub-burn prevention unit 530. As temperatures of the sub-flange portion 532 and the sub-support portion 531 rise due to the heat, the sub-flange portion 532 and the sub-support portion 531 may lose their magnetism due to magnetic phase transition. Accordingly, an attractive force acting between the sub-flange portion 532 and the sub-support portion 531 may be lost or weakened.

When the attractive force applied between the sub-flange portion 532 and the sub-support portion 531 is lost or weakened, an elastic force of the sub-elastic member 535 located between the sub-flange portion 532 and the sub-support portion 531 may be provided to the second bar portion 520 in a direction away from the container unit 100. Accordingly, when heat is provided to the handle unit 501, the second bar portion 520 may move away from the container unit 100 due to the expansive force of the sub-thermal expansion member 550 and the elastic force of the sub-elastic member 535.

As the second bar portion 520 moves away from the container unit 100, the second bar portion 520 may minimize absorption of heat transferred from the container unit or a heating source. Accordingly, a temperature of the second bar portion 520 may be prevented from rising to a certain temperature or more, thereby preventing the cook from being burned by the handle unit 501.

In addition, although the embodiments of the disclosure have been illustrated and described above, the disclosure is not limited to the above-described specific embodiments. Various modified embodiments may be made by one of ordinary skill in the art without departing from the scope of the disclosure as claimed in the claims, and these modifications should not be individually understood from the technical spirit or the prospect of the disclosure.

1. A cooking utensil for preventing burns comprising:
a container unit that is open at top and contains ingredients therein; and
a burn prevention unit provided on an upper side of the container unit,
wherein the container unit comprises a bottom portion, a peripheral portion extending upward from a boundary of the bottom portion, and an insertion groove recessed from an upper end of the peripheral portion toward the bottom portion,
wherein the burn prevention unit comprises:
a support portion located in the insertion groove;
a cap portion located on the support portion and formed of a material having a lower thermal conductivity than the container unit;
a flange portion located in the insertion groove and spaced apart from a lower side of the support portion;
at least one elastic member located between the flange portion and the support portion and configured to provide an elastic force to the support portion in an upward direction;
at least one first protrusion protruding from the support portion toward the flange portion and inserted into the at least one elastic member; and
at least one second protrusion protruding from the flange portion toward the support portion to face the at least one first protrusion and inserted into the at least one elastic member, and
wherein the flange portion and the support portion are formed of magnetic materials exerting attractive forces on each other.

2. The cooking utensil for preventing burns of claim 1, wherein each of the insertion groove, the support portion, and the flange portion has a ring shape in a plan view,
wherein the at least one first protrusion comprises a plurality of first protrusions and the at least one second protrusion comprises a plurality of second protrusions, and
wherein the plurality of first protrusions are arranged along a circumference of the support portion, and the plurality of second protrusions are arranged along a circumference of the flange portion.

3. The cooking utensil for preventing burns of claim 2, wherein the container unit comprises:
at least one first flow path located in the peripheral portion and extending from the insertion groove toward the bottom portion; and
a thermal expansion member located in the at least one first flow path and expanded and contracted by heat, and
wherein the burn prevention unit moves in a vertical direction according to expansion and contraction of the thermal expansion member.

4. The cooking utensil for preventing burns of claim 3, wherein the first flow path comprises a plurality of first flow paths, and
wherein the plurality of first flow paths are arranged along a circumference of the container unit.

5. The cooking utensil for preventing burns of claim 4, wherein the container unit comprises at least one second flow path located in the bottom portion and connected to the at least one first flow path, and
wherein the thermal expansion member is located in the at least one first flow path and the at least one second flow path.

6. The cooking utensil for preventing burns of claim 5, wherein the container unit comprises a coil portion located in the bottom portion and spirally surrounding the at least one second flow path.

7. The cooking utensil for preventing burns of claim 1, further comprising a handle unit provided on the container unit and held by a cook with his/her hand,
wherein the handle unit comprises:
a first bar portion having one end connected to the container unit;
a second bar portion connected to the other end of the first bar portion; and
a sub-burn prevention unit provided between the first bar portion and the second bar portion,
wherein the first bar portion comprises:
a third flow path recessed from the other end of the first bar portion toward the container unit;
a sub-thermal expansion member located in the third flow path and expanded and contracted by heat; and
a sub-groove recessed from the other end of the first bar portion toward the container unit, and recessed from an inner wall of the first bar portion in a direction away from the third flow path,
wherein the second bar portion comprises a first guide insertion portion inserted into the sub-groove and the third flow path,
wherein the sub-burn prevention unit comprises:
a sub-support portion provided in the first guide insertion portion;
a sub-flange portion located in the third flow path and the sub-groove and spaced apart from the sub-support portion;
a first sub-protrusion protruding from the sub-support portion toward the sub-flange portion;
a second sub-protrusion protruding from the sub-flange portion toward the sub-support portion; and
at least one elastic member located between the sub-flange portion and the sub-support portion and configured to provide an elastic force to the sub-support portion in a direction away from the container unit, and
wherein the sub-flange portion and the sub-support portion are formed of magnetic materials exerting attractive forces on each other.

8. A cooking utensil for preventing burns comprising:
a container unit that is open at top and contains ingredients therein; and
a burn prevention unit provided on an upper side of the container unit,
wherein the container unit comprises:
a bottom portion;
a peripheral portion extending upward from a boundary of the bottom portion;
at least one first flow path located in the peripheral portion and extending from an upper end of the peripheral portion toward the bottom portion;
a stopper groove located adjacent to the upper end of the peripheral portion and recessed from an inner wall of the peripheral portion in a direction away from the at least one first flow path; and
a thermal expansion member located in the at least one first flow path and expanded and contracted by heat,
wherein the burn prevention unit comprises:
a support portion located on the peripheral portion;
at least one inserted protrusion protruding from the support portion toward the bottom portion and inserted into the at least one first flow path; and
a flange portion protruding in a direction away from a lower end of the at least one inserted protrusion and located in the stopper groove,
wherein the stopper groove is spaced apart from the upper end of the peripheral portion, and a width of the stopper groove is greater than a width of the at least one first flow path,
wherein the burn prevention unit is located on the upper end of the peripheral portion and moves in a vertical direction according to expansion and contraction of the thermal expansion member, and
wherein the flange portion moves in the vertical direction in the stopper groove.

9. The cooking utensil for preventing burns of claim 8, wherein the burn prevention unit further comprises:
a first magnet member located on the support portion;
a second magnet member located on the peripheral portion; and
an elastic member located between the first magnet member and the second magnet member,
wherein an attractive force acts between the first magnet member and the second magnet member, and
wherein the elastic member is configured to provide an elastic force to the first magnet member and the second magnet member in a direction opposite to the attractive force acting between the first magnet member and the second magnet member.
